(19) United States
(12) Patent Application Publication
(10) Pub. No.: US 2026/0031084 A1
(43) Pub. Date: Jan. 29, 2026

(54) SPEECH DATA PROCESSING METHOD, SPEECH DATA PROCESSING DEVICE AND SPEECH CONTROL SYSTEM

(71) Applicants: Beijing BOE Technology Development Co., Ltd., Beijing (CN); BOE TECHNOLOGY GROUP CO., LTD., Beijing (CN)

(72) Inventors: Bingqian WANG, Beijing (CN); Ran DUAN, Beijing (CN); Youxiang XIA, Beijing (CN)

(21) Appl. No.: 18/994,678

(22) PCT Filed: Apr. 17, 2024
(86) PCT No.: PCT/CN2024/088339

§ 371 Date: Jan. 15, 2025

(30) Foreign Application Priority Data
May 31, 2023 (CN) 202310639508.5

(51) Int. Cl. G10L 15/22; G05B 19/05; G06N 3/0464; G06N 3/0895; G10L 15/06; G10L 15/08; G10L 15/16

(52) U.S. Cl. CPC G10L 15/22; G05B 19/054; G06N 3/0464; G06N 3/0895; G10L 15/063; G10L 15/16; G10L 2015/088; G10L 2015/225

(57) ABSTRACT

The present disclosure relates to the technical field of computers, and provides a speech data processing method and device. The method includes: acquiring speech data to be processed; sending said speech data to a programmable logic unit to perform speech feature extraction on said speech data, to acquire a speech feature vector corresponding to said speech data; in programmable logic unit, converting the speech feature vector into a multi-channel input feature map; sending the input feature map to a computer-in-memory chip, and performing speech keyword spotting on the input feature map by using a pre-configured speech keyword spotting model on the computer-in-memory chip to obtain a speech keyword spotting result; and feeding back the speech keyword spotting result to a main control system, the main control system is configured to execute, according to the speech keyword spotting result, a response operation corresponding to the speech keyword spotting result.

### TECHNICAL FIELD

The present disclosure relates to the field of computer technology, and in particular to a speech data processing method, a speech data processing device, a method for training a speech keyword spotting model, a speech control system, an electronic device, and a computer-readable storage medium.

### BACKGROUND

With the development of hardware technologies such as artificial intelligence (AI) algorithms and AI chips, an intelligent device, such as an intelligent home speech control system, an intelligent speaker, or an intelligent conference system or the like, has been widely used in daily life. The application of the speech interaction in the intelligent device is extremely wide and is increasingly mature. In a conventional speech interaction scenario, the device is initially woken up by clicking a button, for example, pressing a record key, to interact with the device.

In order to further improve human-computer interaction experience, a speech keyword spotting technology has been emerged, and speech wake-up or keyword spotting (Speech Keyword Identification) is a sub-field of speech recognition (Speech Recognition). The principle of the speech recognition is to extract useful information from a continuous speech signal and convert the information into a character string which is recognizable by the computer, where the character string is generally a binary character stream, or the text content. The speech keyword spotting does not need to recognize the whole speech signal, and only needs to judge whether the signal contains a certain keyword or certain keywords.

At present, the speech keyword spotting process mainly includes three types: a template matching based wake-up technology, a hidden Markov model based wake-up technology, and a deep learning based wake-up technology. The deep learning based speech recognition wake-up method is most widely used.

### SUMMARY

The present disclosure provides a speech data processing method, a speech data processing device, a method for training a speech keyword spotting model, a speech control system, an electronic device, and a computer-readable storage medium.

According to a first aspect of the present disclosure, the present disclosure provides a speech data processing method, including: acquiring speech data to be processed; inputting the speech data to be processed into a programmable logic unit to perform a speech feature extraction on the speech data to be processed so as to obtain a speech feature vector corresponding to the speech data to be processed; converting the speech feature vector into a multi-channel input feature map in the programmable logic unit; inputting the input feature map into a computer-in-memory chip, and performing a speech keyword spotting process on the input feature map by using a speech keyword spotting model, which is configured on the computer-in-memory chip in advance, to obtain a speech keyword spotting result; and feeding back the speech keyword spotting result to a main control system, and the main control system is configured to execute a response operation corresponding to the speech keyword spotting result according to the speech keyword spotting result.

In some embodiments, the performing the speech feature extraction on the speech data to be processed so as to obtain the speech feature vector corresponding to the speech data to be processed, includes: performing the speech feature extraction on the speech data to be processed with a preset speech feature extraction algorithm so as to obtain the speech feature vector corresponding to the speech data to be processed.

In some embodiments, the speech feature vector is a two-dimensional speech feature vector, and the converting the speech feature vector into the multi-channel input feature map, includes: performing feature dimension expansion on the speech feature vector to obtain a three-dimensional speech feature vector; copying the three-dimensional speech feature vector to obtain a plurality of three-dimensional speech feature vectors; and splicing the plurality of three-dimensional speech feature vectors according to a channel dimension to obtain the multi-channel input feature map, wherein the channel dimension refers to a feature channel of the speech feature vectors.

In some embodiments, the speech keyword spotting model is a model constructed based on a convolution mixer network ConvMixer architecture, and includes a feature sampling layer, the convolution mixer network and a classification output layer; and the performing the speech keyword spotting process on the input feature map by using the speech keyword spotting model, which is configured on the computer-in-memory chip in advance, to obtain the speech keyword spotting result, includes: performing a down-sampling process on the input feature map by using the feature sampling layer to obtain a down-sampled feature map; performing a convolution mixer process on the down-sampled feature map by utilizing the convolution mixer network to obtain a speech recognition feature map; and performing a keyword classification prediction process on the speech recognition feature map by using the classification output layer to obtain the speech keyword spotting result.

In some embodiments, the feature sampling layer includes: a patch embedding layer, a first batch normalization layer and a first activation function layer; and wherein the patch embedding layer is realized based on a convolution layer, and the activation function layer adopts a Swish activation function.

In some embodiments, the convolution mixer network includes at least one convolution mixer network module, each convolution mixer network module includes a space position convolution mixer unit and a channel position convolution mixer unit, and a space position mixer processing result output by the space position convolution mixer unit and an input of the space position convolution mixer unit are input to the channel position convolution mixer unit through a residual connection for a channel position mixer processing; wherein the space position convolution mixer unit includes: a depthwise separable convolution layer, a second batch normalization layer and a second activation function layer which are connected sequentially; the channel position convolution mixer unit includes: a pointwise convolution layer, a third batch normalization layer and a third activation function layer which are connected sequentially; and wherein the second activation function layer and the third activation function layer both adopt Swish activation functions.

In some embodiments, the classification output layer includes: an average pooling layer and a fully connected layer; and the fully connected layer is realized by adopting a convolution layer.

According to a second aspect of the present disclosure, the present disclosure provides a method for training a speech keyword spotting model, including: acquiring an initial training data set, wherein the initial training data set includes a plurality pieces of initial training speech data and keyword labels corresponding to the plurality pieces of initial training speech data; performing a data augmentation process on at least part of the initial training speech data in at least one data augmentation mode to obtain at least one piece of augmented training speech data and a keyword label corresponding to the augmented training speech data; and training the speech keyword spotting model according to the initial training speech data and the augmented training speech data to obtain a trained speech keyword spotting model.

In some embodiments, the at least one data augmentation mode includes: a data mixing mode, a data noise adding mode, a negative sample construction mode, a velocity disturbance mode and a spectrum enhancement mode.

In some embodiments, the training the speech keyword spotting model, includes: training the speech keyword spotting model based on a quantification aware training method.

According to a third aspect of the present disclosure, the present disclosure provides a speech data processing device, including: an acquisition unit configured to acquire speech data to be processed; a feature extraction unit configured to input the speech data to be processed into a programmable logic unit to perform a speech feature extraction on the speech data to be processed so as to obtain a speech feature vector corresponding to the speech data to be processed; a feature conversion unit configured to convert the speech feature vector into a multi-channel input feature map in the programmable logic unit; a detection unit configured to input the input feature map into a computer-in-memory chip, and perform speech keyword spotting on the input feature map by using a speech keyword spotting model, which is configured on the computer-in-memory chip in advance, to obtain a speech keyword spotting result; and a response unit configured to feed back the speech keyword spotting result to a main control system, and the main control system is configured to execute a response operation corresponding to the speech keyword spotting result according to the speech keyword spotting result.

According to a fourth aspect of the present disclosure, the present disclosure provides a speech control system, including: a sound acquisition device configured to acquire speech data to be processed in an environment where the sound acquisition device is located, and send the speech data to be processed to a main control system; the main control system configured to receive the speech data to be processed acquired by the sound acquisition device, and send the speech data to be processed to a programmable logic unit; the programmable logic unit configured to perform speech feature extraction on the speech data to be processed to obtain a speech feature vector corresponding to the speech data to be processed, and convert the speech feature vector into a multi-channel input feature map; a computer-in-memory chip integrated with a preset speech keyword spotting model, and configured to perform speech keyword spotting on the input feature map by using a speech keyword spotting model, which is configured on the computer-in-memory chip in advance, to obtain a speech keyword spotting result; and the main control system is further configured to receive the speech keyword spotting result from the computer-in-memory chip, and control a terminal device to execute a corresponding response operation according to the speech keyword spotting result; and the terminal device is configured to execute the response operation corresponding to the speech keyword spotting result.

According to a fifth aspect of the present disclosure, the present disclosure provides an electronic device, including: at least one processor; and a memory communicatively connected to the at least one processor; the memory stores one or more computer programs executable by the at least one processor, which are executed by the at least one processor to cause the at least one processor to perform the speech data processing method or the method for training a speech keyword spotting model.

According to a sixth aspect of the present disclosure, the present disclosure provides a computer-readable storage medium, on which a computer program is stored, the computer program, when being executed by a processor, implements the speech data processing method or performs the method for training a speech keyword spotting model.

### BRIEF DESCRIPTION OF DRAWINGS

The accompanying drawings, which are provided for further understanding of the present disclosure and constitute a part of this specification, are for explaining the present disclosure together with the embodiments of the present disclosure, but are not intended to limit the present disclosure. The above and other features and advantages will become more apparent to one of ordinary skill in the art by describing in detail exemplary embodiments thereof with reference to the drawings. In the drawings:

FIG. 1 is a schematic flowchart of a speech data processing method according to an embodiment of the present disclosure.

FIG. 2 is a schematic diagram of a model architecture of a speech keyword spotting model according to an embodiment of the present disclosure.

FIG. 3 is a schematic diagram of a structure of a speech data processing device according to an embodiment of the present disclosure.

FIG. 4 is a schematic diagram of a structure of a speech control system according to an embodiment of the present disclosure.

FIG. 5 is a schematic diagram of an application scenario of a speech control system according to an embodiment of the present disclosure.

FIG. 6 is a schematic diagram of another application scenario of a speech control system according to an embodiment of the present disclosure.

FIG. 7 is a block diagram of an electronic device according to an embodiment of the present disclosure.

### DETAIL DESCRIPTION OF EMBODIMENTS

In order to enable one of ordinary skill in the art to better understand the technical solutions of the present disclosure, the exemplary embodiments of the present disclosure will be described below with reference to the accompanying drawings, and various details of the embodiments of the present disclosure are included to better understand the technical solutions, and should be considered as being merely exemplary. Accordingly, it should be recognized by one of ordinary skill in the art that various changes and modifications of the embodiments described herein may be made without departing from the scope and the spirit of the present disclosure. Also, a description for well-known functions and structures are omitted in the following description for clarity and conciseness.

Embodiments of the present disclosure and features of the embodiments may be combined with each other in case of no conflict.

As used herein, the term “and/or” includes any and all combinations of one or more of the associated listed items.

The terms used herein are for the purpose of describing particular embodiments only and are not intended to limit the present disclosure. As used herein, the singular forms “a”, “an” and “the” are intended to include a plural form as well, unless the context clearly indicates otherwise. It should be further understood that the terms of “including” and/or “comprising,” when used in this specification, specify the presence of stated features, integers, steps, operations, elements, and/or components, but do not preclude the presence or addition of one or more other features, integers, steps, operations, elements, components, and/or groups thereof. The term “connected”, “coupled”, or the like is not limited to physical or mechanical connections, but may include electrical connections, whether direct or indirect connections.

Unless otherwise defined, all terms (including technical and scientific terms) used herein have the same meaning as commonly understood by one of ordinary skill in the art. It should be further understood that terms, such as those defined in commonly used dictionaries, should be interpreted as having a meaning that is consistent with their meaning in the context of the relevant art and the present disclosure, and should not be interpreted in an idealized or overly formal sense unless expressly so defined herein.

In the related art, in order to realize a good interaction experience between the human and the intelligent device, the intelligent device monitors the speech in real time, which causes a serious problem, that is, a consumption of a speech keyword spotting model to a resource such as a power supply, or the storage space or the like. Generally, the intelligent device, such as a smart watch, or a blue-tooth speaker or the like, is not directly connected to the power supply, but adopts a battery. The power consumption problem of the speech keyword spotting function directly influences the service time and the speed of service of the intelligent device.

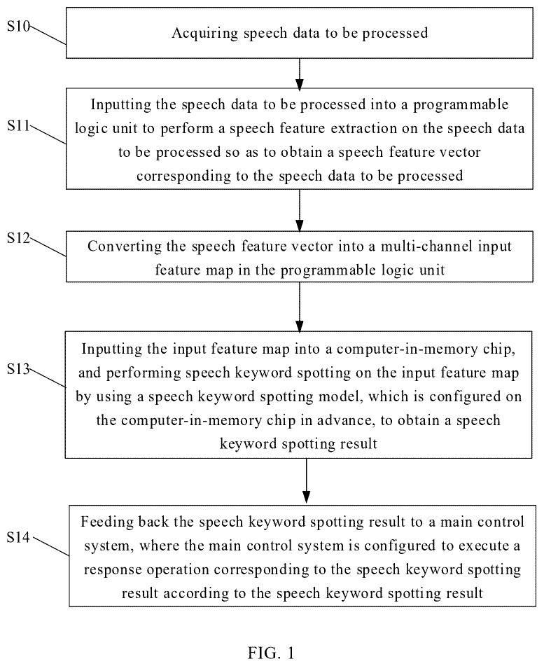

FIG. 1 is a schematic flowchart of a speech data processing method according to an embodiment of the present disclosure. As shown in FIG. 1, the speech data processing method includes steps S10 to S14.

The step S10 includes acquiring speech data to be processed.

The step S11 includes inputting the speech data to be processed into a programmable logic unit to perform a speech feature extraction on the speech data to be processed so as to obtain a speech feature vector corresponding to the speech data to be processed.

For the steps of acquiring the speech data to be processed, inputting the speech data to be processed into the programmable logic unit, and performing the speech feature extraction on the speech data to be processed by the programmable logic unit. Specifically, the speech feature extraction is performed on the speech data to be processed with a preset speech feature extraction algorithm so as to obtain the speech feature vector corresponding to the speech data to be processed.

For example, the speech feature extraction is performed on the speech data to be processed based on mel frequency cepstrum coefficient (MFCC, a speech feature extraction algorithm), so as to obtain the speech feature vector corresponding to the speech data to be processed.

In the embodiment of the present disclosure, the speech feature vector extracted based on the mel frequency cepstrum coefficient (MFCC) is an Fbank feature, and is a two-dimensional speech feature vector.

In the MFCC algorithm, the extraction of the Fbanks feature involves performing processes, including pre-emphasis, framing, windowing, Fourier transform, power spectrum computation, and filtering through mel filter banks, and the like, on the speech data in sequence.

Specifically, the pre-emphasis process is performed on the speech data, where the pre-emphasis process is a signal processing method for compensating a high-frequency component of an input signal at a transmitting terminal, so as to increase an energy of a high-frequency component in the speech data and improve a signal-to-noise ratio.

Furthermore, the framing process is performed on the speech data subjected to the pre-emphasis process to obtain a plurality of audio frames. Here, the framing process refers to dividing the speech data into speech signal segments with a fixed size, and each speech signal segment is called a frame with a frame length generally in a range from 20 milliseconds to 40 milliseconds. In the framing process, an overlapping segmentation method may be adopted, and a ratio of a frame shift to the frame length is in a range from 0 to ½, where the frame shift is an overlapping portion of two adjacent frames. By utilizing the short-time stationarity of the signal, a smooth transition between the frames is realized, the continuity of the frames is maintained, the problem of information omission caused by a boundary of a time window can be avoided, and the influence on the windowing process is reduced. In the embodiment of the present disclosure, the frame length is 25 ms, the frame shift is 10 ms, a sampling frequency of the speech data is 16000/s, and a length of the speech data is 1s.

Further, the windowing process is performed on each audio frame. If beginning values of the audio frames in the speech data are the same and end values of the audio frames are the same, it may be assumed that the frame has a periodicity, and a length of the periodicity is exactly equal to a length of the frame. In the windowing process, the beginning values are the same and the end values are the same by adding different weights to sampling points of the speech data, so as to eliminate the signal discontinuity that may be caused by the beginning and end of each frame.

Furthermore, the Fourier transform is performed on each audio frame to obtain corresponding spectrum information of each audio frame. The Fourier transform is used to convert a time domain signal to a frequency domain signal. In some embodiments, the speech data is a sampled digital signal, which is a discrete value. Therefore, the Fourier transform may adopt the discrete Fourier transform (DFT).

Further, a power spectrum is calculated according to the spectrum information corresponding to the audio frame, and the power spectrum is a ratio of the square of the modulus of the spectrum information obtained by the Fourier transform to the length.

Further, the power spectrum of each audio frame is filtered by the mel filter banks to obtain a spectral feature of each audio frame. The Mel filter bank may be a triangular filter bank, and the power spectrum is processed by a triangular filter to obtain a one-dimensional vector, and processed by a triangular filter bank to obtain a two-dimensional matrix. Further, a logarithmic calculation is performed on a spectral feature of the two-dimensional matrix to obtain the Fbank feature, wherein the logarithmic calculation adopts a logarithmic function with a base of 10 for the calculation.

For example, a length of the Fbank feature vector is 64, that is, a 98×64 two-dimensional Fbank feature vector may be obtained after the speech feature extraction is performed on the speech data by using the MFCC. The Fbank feature vector is expanded into a three-dimensional vector, to obtain a tensor with a shape of [1, 98, 64], like a feature image with a length of 98, a width of 64 and the number of channels of 1.

The step S12 includes converting the speech feature vector into a multi-channel input feature map in the programmable logic unit.

The two-dimensional speech feature vector is converted into a multi-channel input feature map in modes including dimension expansion, feature replication, feature splicing and the like in the programmable logic unit.

In some embodiments, in the step S12, the converting the speech feature vector into the multi-channel input feature map may further include: performing feature dimension expansion on the speech feature vector to obtain a three-dimensional speech feature vector, copying the three-dimensional speech feature vector to obtain a plurality of three-dimensional speech feature vectors, for example, copying the three-dimensional speech feature vectors into three three-dimensional speech feature vectors, which are a first speech feature vector, a second speech feature vector and a third speech feature vector, respectively; and splicing the plurality of three-dimensional speech feature vectors according to a channel dimension to obtain the multi-channel input feature map, wherein the channel dimension refers to a feature channel of the speech feature vectors.

In some embodiments, the feature dimension expansion may be performing on the speech feature vector by using an unsequeeze function. The unsequeeze function is an operation function for adding a dimension with a dimension value of 1 at a specified position of the data. For example, the speech feature vector, which is the 98×64 two-dimensional Fbank feature vector, is expanded into the three-dimensional feature vector by using the unsequeeze function, to obtain the tensor with the shape of [1, 98, 64], like the feature image with the length of 98, the width of 64 and the number of channels of 1.

In some embodiments, the plurality of three-dimensional speech feature vectors may be spliced by using a concat function according to the channel dimension, so as to obtain the multi-channel input feature map, where the number of channels of the input feature map is 3. The concat function is an operation function for splicing two or more tensors in a dimension.

The step S13 includes inputting the input feature map into a computer-in-memory chip, and performing speech keyword spotting on the input feature map by using a speech keyword spotting model, which is configured on the computer-in-memory chip in advance, to obtain a speech keyword spotting result.

In the embodiment of the present disclosure, the speech keyword spotting model is configured on the computer-in-memory chip in advance to obtain a pre-configured speech keyword spotting model, in the step S13, the multi-channel input feature map is input to the computer-in-memory chip, and the speech keyword spotting is performed by using the pre-configured speech keyword spotting model, so as to obtain the speech keyword spotting result.

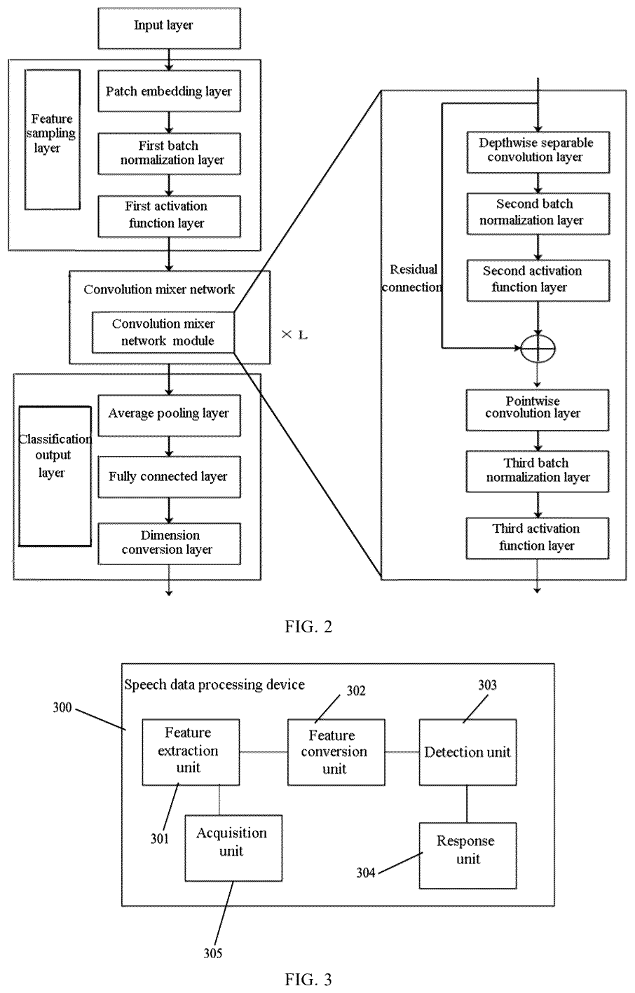

FIG. 2 is a schematic diagram of a model architecture of a speech keyword spotting model according to an embodiment of the present disclosure. In some embodiments, the speech keyword spotting model is a model constructed based on a convolution mixer network ConvMixer architecture. As shown in FIG. 2, the speech keyword spotting model constructed based on the ConvMixer architecture includes an input layer, a feature sampling layer, the convolution mixer network ConvMixer, and a classification output layer, which are connected in sequence, where the input layer is used to input the input feature map to the feature sampling layer.

Specifically, the performing the speech keyword spotting on the input feature map by using the speech keyword spotting model which is configured in advance on the computer-in-memory chip to obtain the speech keyword spotting result, may further include the following steps:

First, a down-sampling process is performed on the input feature map by using the feature sampling layer to obtain a down-sampled feature map.

As shown in FIG. 2, the feature sampling layer includes: a patch embedding layer, a first batch normalization layer (BN) and a first activation function layer. The patch embedding layer is realized on the basis of a convolution layer, and the activation function layer adopts a Swish activation function.

The patch embedding layer is used for down-sampling the input feature map, the first batch normalization layer is a BN layer for performing a normalization process on input features, and the first activation function layer is used for changing a linear relationship of the data and performing a de-linearization process (that is, a nonlinear transformation process) on the data.

Given that a size of a patch is p, an embedding dimension is h, and the number of channels of the input feature map is Cin, the output Z₀ of the patch embedding layer may be represented as:

$${z}_{0} = σ ( BN ( {Conv}_{cin \to h} ( X , stride = p , kernel\_size = p ) ) )$$

For example, in the above formula, p is 64, kernel_size=p is 5×5 two-dimensional (2D) convolution, and the output of the patch embedding layer is followed by a Swish activation function σ and a batch normalization layer (BN layer). That is, the down-sampled feature map is a tensor which may be represented as [Batch size, 64, 25, 13], that is, a tensor represented as [Batch size, 64, 25, 13] and finally input to the convolution mixer network ConvMixer. The down-sampling process for the feature map is completed through the patch embedding layer, so that the resolution of the feature map is reduced, the receptive field is increased, the spatial information of the deep layer is easier to find, and the calculation amount and parameter amount of the convolution mixer network ConvMixer are reduced, thereby reducing the occupation of the model on the space of the storage resource and reducing the consumption of the model on the calculation resource.

Then, a convolution mixer process is performed on the down-sampled feature map by utilizing the convolution mixer network to obtain a speech recognition feature map.

As shown in FIG. 2, the convolution mixer network includes at least one convolution mixer network module (ConvMixer-Block), the number of the convolution mixer network modules is L, the L convolution mixer network modules are connected in series sequentially, and a value of L may be set according to actual needs. Each convolution mixer network module includes a space position convolution mixer unit and a channel position convolution mixer unit, and a space position mixer processing result output by the space position convolution mixer unit and an input of the space position convolution mixer unit are input to the channel position convolution mixer unit through a residual connection for a channel position mixer processing.

As shown in FIG. 2, the space position convolution mixer unit includes: a depthwise separable convolution (ConvDepthwise) layer, a second batch normalization (BN) layer and a second activation function layer which are connected sequentially. As shown in FIG. 2, the channel position convolution mixer unit includes: a pointwise convolution (ConvPointwise) layer, a third batch normalization layer and a third activation function layer which are connected sequentially. The second activation function layer and the third activation function layer both adopt Swish activation functions.

In some embodiments, in the convolution mixer network module, the depthwise separable convolution (ConvDepthwise) layer is selected to mix space position features, the pointwise convolution (ConvPointwise) layer (with a convolution kernel size of 1×1) is selected to mix channel position features, and the model is effectively guaranteed to have a small network parameter amount, the number of channels of the convolution layer is consistent with the embedding dimension h of the patch embedding layer, and the convolution mixer network module (ConvMixer-Block) may be represented as:

$${z}_{l}^{′} = σ ( BN ( ConvDepthwise ( {z}_{l - 1} ) ) ) + {z}_{l - 1}$$

$${z}_{l} = σ ( BN ( ConvPointwise ( {z}_{l}^{′} ) ) )$$

Where BN is a batch normalization layer and σ is a swish activation function.

Finally, a keyword classification prediction process is performed on the speech recognition feature map by using the classification output layer to obtain the speech keyword spotting result.

As shown in FIG. 2, the classification output layer includes: an average pooling layer and a fully connected layer. The fully connected layer is realized by a convolution layer (Conv2d), the average pooling layer is a 2D average pooling layer, the convolution layer in the fully connected layer is a convolution layer with a convolution kernel size of 1×1, and the number of output channels is equal to the number of preset categories of the keywords.

In the embodiment of the present disclosure, the convolution layer is used as the fully connected layer, so that a size of a model parameter can be significantly reduced, and the calculation amount for the model is reduced, thereby advantageously reducing the occupation of the model on the space of the storage resource and reducing the consumption of the model on the calculation resource.

Specifically, the speech recognition feature output by the convolution mixer network is input into the 2D average pooling layer for the pooling process, and then the keyword classification prediction process is performed through the fully connected layer adopting a softmax activation function, to obtain an output result including N+2 categories, where N is the total number of preset speech wake-up words and speech command words, and 2 represents a silence category and an unknow category, that is, the categories of the speech keywords include the speech wake-up words, the speech command words, the silence category and the unknow category, the speech wake-up words include, but are not limited to, a character string composed of not less than four Chinese letters such as “Mr. X, Mr. X”, or “hello, Mr. X”, or the like, the speech command words include, but are not limited to, a series of control commands such as “turn on air conditioner”, “increase volume”, or “turn up brightness”, or the like, and the output result may indicate a probability of the keyword category to which the speech data belongs. According to the output result of the fully connected layer, the speech keyword spotting result is obtained, and exemplarily, the category with the highest probability may be selected as the speech keyword spotting result, or the category with the probability greater than a preset threshold may be selected as the speech keyword spotting result.

In some embodiments, as shown in FIG. 2, a dimension conversion (view) layer is further disposed behind the fully connected layer, and is configured to perform a dimension conversion on the output result of the fully connected layer to obtain the output result with a desired dimension.

The step S14 includes feeding back the speech keyword spotting result to a main control system, and the main control system is configured to execute a response operation corresponding to the speech keyword spotting result according to the speech keyword spotting result.

For example, when the speech keyword spotting result is a speech wake-up word, the intelligent speech control device may be controlled to respond. For example, if the input speech data is “Mr. X, Mr. X”, the response of the intelligent speech control device may be “Mr. X is here”, “I'm here” or the like. When the speech keyword spotting result is a speech command word, a corresponding intelligent terminal may be controlled to execute a corresponding control command. For example, when the speech command word is “turn on the air conditioner”, the air conditioner may be controlled to be turned on and execute a preset or last set operation. When the speech command word is “increase the volume”, a player currently in a playing state may be controlled to increase the volume by one level. When the speech command word is “turn up brightness”, a lighting device currently in a lighting state may be controlled to turn up the brightness by one level.

A neural network model is formed by connecting a series of network layers, each layer receives and processes the output of the previous layer to obtain a result, which is used as the input of the next layer, and each layer of the neural network model has respective parameters. During a training process, a change of parameters of a layer will cause the change of the output of the layer, that is, the input distribution of the next layer, and the change will be amplified continuously through a layer by layer accumulation. In each iteration, with the update of parameters, the distribution of input features is changed, and the parameters of the neural network model need to adapt to the input distribution again, so that the training complexity of the neural network model is greatly increased. The problem can be effectively solved by the batch normalization layer (BN). The batch normalization layer performs a similar normalization operation on the input features, so that the distribution of the input features can be stabilized, and the training process of the neural network model is accelerated.

In the embodiment of the present disclosure, in the feature sampling layer and the convolution mixer network of the speech keyword spotting model, each batch normalization layer is located behind the corresponding convolution layer and is connected in series with the convolution layer, and therefore, the batch normalization layer and the convolution layer can be fused, so that the network calculation can be accelerated, the calculation amount and parameter amount of the model can be reduced, the occupation of the model on the space of the storage resource can be reduced, and the consumption of the model on the calculation resource can be reduced.

For example, assume the convolution calculation method with offset is as follows:

$$y = x * w + b$$

The calculation formula of the BN layer is as follows:

$$z = β \frac{y - {y}_{mean}}{{y}_{var}} + γ$$

The following is obtained by bringing y into z:

$$z = β \frac{( x \cdot w + b ) - {y}_{mean}}{{y}_{var}} + γ = \frac{x * β \cdot w}{{y}_{var}} + β \frac{b - {y}_{mean}}{{y}_{var}} + γ$$

Let wₙ=β·w/yᵥₐᵣ, bₙ=B·(b−yₘₑₐₙ)/yᵥₐᵣ+γ, where x denote the input, w denote the weights, b, γ, β are constants, mean denotes the mean value, and var denotes the variance.

A new convolution parameter obtained after the convolution layer and the BN layer are fused may be expressed as:

$$z = x * {w}_{n} + {b}_{n}$$

In the embodiment of the present disclosure, the speech keyword spotting model is integrated into the computer-in-memory chip configured to perform the speech keyword spotting.

In the embodiment of the present disclosure, compared with a traditional von Neumann architecture chip, the computer-in-memory chip can effectively reduce the computing power consumption. Specifically, in the von Neumann architecture chip, a computing unit is separated from a memory, it is necessary to read the data from the memory to complete the computation for the data, and write the data back to the memory after the computation is completed, so that huge power consumption is generated by data transmission between the computing unit and the memory. The computer-in-memory chip embeds the computing function into the memory, the storage function and the computing function are integrated, in the operation process of the speech keyword spotting model, the data transmission between the computing unit and the memory is reduced, the memory adopts an analog circuit, rather than a traditional digital circuit, to realize the computation with a lower power consumption.

In the embodiment of the present disclosure, the speech keyword spotting model based on the ConvMixer architecture has a better precision, maintains a smaller amount of the model parameters, and therefore, can be conveniently integrated in the computer-in-memory chip with a low power consumption, and realizes the speech keyword spotting with the low power consumption and a low delay.

According to the speech data processing method provided by the embodiment of the present disclosure, the lightweight speech keyword spotting model is integrated with the computer-in-memory chip with the low power consumption to detect and recognize the speech keywords, so that the speech keyword spotting can be realized with the low power consumption and the low delay, the task of recognizing the wake-up words and the command words can be realized simultaneously without an additional speech recognition model, and the speech data processing method may be applied to an edge device, or applied to a terminal device to realize the functions of waking up or controlling a device through the speech or the like.

The embodiment of the present disclosure further provides a method for training a speech keyword spotting model, including: acquiring an initial training data set, the initial training data set includes a plurality pieces of initial training speech data and keyword labels corresponding to the plurality pieces of initial training speech data, and the keyword labels corresponding to the plurality pieces of initial training speech data are keyword categories to which the pre-labeled initial training speech data belongs, such as the speech wake-up word or the speech command word; performing a data augmentation process on at least part of the initial training speech data in at least one data augmentation mode to obtain at least one piece of augmented training speech data and a keyword label corresponding to the augmented training speech data; and training the speech keyword spotting model according to the initial training speech data and the augmented training speech data to obtain the trained speech keyword spotting model.

In some embodiments, the at least one data augmentation mode includes: a data mixing mode, a data noise adding mode, a negative sample construction mode, a velocity disturbance mode and a spectrum enhancement mode.

The data mixing mode is a data enhancement method based on the Mixup, and for the supervised learning task, the data mixing Mixup mode is an effective data enhancement strategy. The mode may combine the initial training speech data with the keyword label, so that the model is more robust to an adversarial sample, and the misjudgment of the model on the sample category is reduced. The data mixing mode is shown below:

$${X}_{mix} = λ {X}_{i} + ( 1 - λ ) {X}_{j}$$

$${Y}_{mix} = λ {Y}_{i} + ( 1 - λ ) {Y}_{j}$$

Where Xᵢ represents the ith piece of initial training speech data, Yᵢ represents the keyword label corresponding to the ith piece of initial training speech data, Xⱼ represents the jth piece of initial training speech data, Yⱼ represents the keyword label corresponding to the jth piece of initial training speech data, and a mixing proportion λ conforms to the Beta distribution, that is, λ˜Beta(α, α), where α may be α=10, Xₘᵢₓ represents the augmented training speech data obtained by performing the data augmentation process in the data mixing mode, and Yₘᵢₓ represents the keyword label corresponding to the augmented training speech data Xₘᵢₓ.

The data noise adding mode is that noise data of a specified type, such as music, background of a television series, or reverberation or the like, is added to given initial training speech data through a specified signal-to-noise ratio. Given the initial training speech data S, the noise data N, and the signal-to-noise ratio SNR, the following can be obtained:

$$SNR = 10 lg ( Ps / Pn )$$

$$Ps = avg ( {s}^{2} ) , Pn = avg ( {n}^{2} )$$

$$scalar = \sqrt{Ps / ( {10}^{SNR / 10} \cdot Pn )}$$

$$Noise = S + scalar \cdot N$$

Where Ps is an average power of the initial training speech data S, Pn is an average power of the noise data N, Noise represents the augmented training speech data obtained by performing the data augmentation process in the data noise adding mode, and the keyword label of the augmented training speech data Noise is the same as that of the initial training speech data S.

For the negative sample construction mode, the speech wake-up/keyword spotting problem has an important index, that is, a false wake-up/false recognition rate. For example, the wake-up word is “hello Xiaojing”, if the model is over-fitted or has a poor robustness, a greeting, such as “hello”, in the normal conversation process may trigger the speech wake-up. In order to avoid this situation, the negative sample may be constructed based on the initial training data set.

A method for constructing the negative sample includes: recognizing the initial training speech data based on an automatic speech recognition (ASR) model, and outputting the keyword label with time stamp information, wherein the ASR may adopt any existing suitable speech recognition model; and segmenting the original initial training speech data based on the timestamp information. For example, the original initial training speech data is “hello Xiaojing”, and is segmented into two audio segments including “hello” and “Xiaojing”, which may be randomly spliced together, to obtain four pieces of negative sample data: “hello”, “Xiaojing”, “hello, hello”, “Xiaojing, hello”.

In addition, different pieces of the initial training speech data may be spliced together to form a new negative sample. For example, the initial training speech data “increase volume” and the initial training speech data “light up screen” are respectively segmented to obtain audio segments “increase”, “volume”, “light up” and “screen”, which are randomly combined and spliced together to obtain the negative samples “increase screen” and “light up volume” and the like.

Finally, the constructed negative sample is used as the augmented training speech data, and the corresponding label is set as an unknown label.

In addition, the training data may also be augmented in the velocity disturbance mode or the spectrum enhancement mode, or the like, which is not described herein.

Through the data augmentation mode, the amount of the training data can be increased, the diversity of the training data is improved, and the robustness of the model is favorably improved.

In the embodiment of the present disclosure, before training the speech keyword spotting model according to the initial training speech data and the augmented training speech data, the speech feature extraction is performed on the speech data to obtain the speech feature vector corresponding to the speech data, and the speech feature vector is converted into the multi-channel input feature map. Then, the input feature map is input into the model for training.

In some embodiments, the training the speech keyword spotting model includes: training the speech keyword spotting model based on a quantification aware training (QAT) method.

In the quantification aware training method, the whole model may be quantized by integer INT8, which involves a pseudo quantification node, the pseudo quantification node refers to a node inserted in the quantification aware training method for searching the data distribution of the model and feeding back precision loss, and the pseudo quantification node has the following specific functions (1) and (2).

The function (1) includes finding the distribution of the network data, that is, the maximum value and the minimum value of the parameter to be quantized.

The function (2) includes simulating the precision loss with a low bit in the quantification, applying the loss to the model and transferring the loss to a loss function, and optimizing, by an optimizer, the loss in the training process.

In some embodiments, the speech keyword spotting model may be obtained by training in advance through the above training method, and then the trained speech keyword spotting model is deployed to the computer-in-memory chip for operation.

In addition, the following validity verification is performed for the speech data processing method provided by the embodiment of the present disclosure: the speech data processing method in the embodiment of the present disclosure is experimentally tested by using a data set of Google Speech Commands V2 (GSC V2), and the GSC V2 contains 105,829 command words, 2,618 speakers, 35 command words including “down”, “go”, “left”, “no”, “off”, “on”, “right”, “stop”, “up”, “yes”, and the like. Experiments are performed using models of different sizes. For example, the speech keyword spotting model of the embodiment of the present disclosure, with a model depth of 8 and a hidden layer size of 64, is referred to as KwsConvMixer-S(KCM-S), the speech keyword spotting model, with a model depth of 12 and a hidden layer size of 64, is referred to as KwsConvMixer-M (KCM-M), and the speech keyword spotting model, with a model depth of 12 and a hidden layer size of 128, is referred to as ConvMixer-L (KCM-L). An adamw optimizer is used in the experiments, warmup epoch is 10, the number of iteration steps is 25,000, the learning rate is 0.02, and the batch size is 256, and the test results are shown in table 1.

TABLE 1

| Model | Number of parameters | Precision % |
|---|---|---|
| DSCNN | 0.42M | 97.2 |
| MHAtt-RNN | 0.784M | 97.27 |
| KWT-1 | 0.607M | 96.85 |
| KWT-2 | 2.394M | 97.53 |
| KWT-3 | 5.361M | 97.51 |
| KW-MLP | 0.424M | 97.56 |
| KCM-S(ours) | 0.05M | 96.24 |
| KCM-M(ours) | 0.08M | 96.7 |
| KCM-L(ours) | 0.26M | 97.9 |

It may be seen that the precision of 96.24 is achieved by the KCM-S model with only the parameter amount of 96 k, while the precision of 97.9 is achieved by the ConvMixer-L with the parameter amount of 0.26M, which shows that the speech keyword spotting model of the embodiment of the present disclosure has the better prediction effect and the smaller model parameter amount compared with the MLP-based model and the transformer-based model.

It is understood that the above method embodiments of the present disclosure may be combined with each other to form a combined embodiment without departing from the principle and logic, which is omitted due to the limited space. It will be appreciated by one of ordinary skill in the art that in the above method of the detail description of embodiments, the specific order of execution of the steps should be determined by the functions and the possibly inherent logics of the steps.

FIG. 3 is a schematic diagram of a structure of a speech data processing device according to an embodiment of the present disclosure. As shown in FIG. 3, the speech data processing device 300 includes: a feature extraction unit 301, a feature conversion unit 302, a detection unit 303, a response unit 304, and an acquisition unit 305.

The acquisition unit 305 is configured to acquire speech data to be processed. The feature extraction unit 301 is configured to input the speech data to be processed into a programmable logic unit to perform a speech feature extraction on the speech data to be processed so as to obtain a speech feature vector corresponding to the speech data to be processed. The feature conversion unit 302 is configured to convert the speech feature vector into a multi-channel input feature map in the programmable logic unit. The detection unit 303 is configured to input the input feature map into a computer-in-memory chip, and perform speech keyword spotting on the input feature map by using a speech keyword spotting model, which is configured on the computer-in-memory chip in advance, to obtain a speech keyword spotting result. The response unit 304 is configured to feed back the speech keyword spotting result to a main control system, and the main control system is configured to execute a response operation corresponding to the speech keyword spotting result according to the speech keyword spotting result.

The speech data processing device 300 provided in the embodiment of the present disclosure is configured to implement the speech data processing method provided in any one of the embodiments, and for specific relevant description, reference may be made to the description in the speech data processing method in any one of the embodiments, and details are not repeated herein.

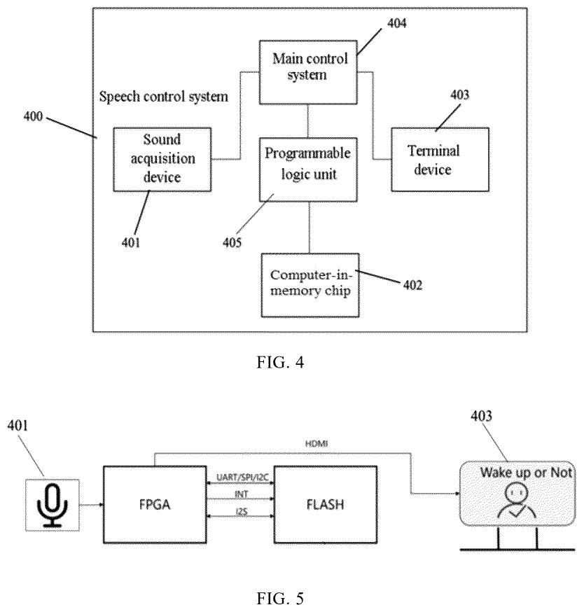

FIG. 4 is a schematic diagram of a structure of a speech control system according to an embodiment of the present disclosure. As shown in FIG. 4, the speech control system 400 includes: a sound acquisition device 401, a computer-in-memory chip (PIM chip) 402, a terminal device 403, a main control system (processing system, PS) 404, and a programmable logic unit (PL) 405.

The sound acquisition device 401 is configured to acquire the speech data to be processed in an environment where the sound acquisition device is located, and send the speech data to be processed to the main control system. The main control system 404 is configured to receive the speech data to be processed acquired by the sound acquisition device 401, and send the speech data to be processed to the programmable logic unit 405. The programmable logic unit 405 is configured to perform the speech feature extraction on the speech data to be processed to obtain the speech feature vector corresponding to the speech data to be processed, and convert the speech feature vector into the multi-channel input feature map. The computer-in-memory chip 402 is integrated with a preset speech keyword spotting model, and is configured to perform the speech keyword spotting on the input feature map by using the speech keyword spotting model, which is configured on the computer-in-memory chip 402 in advance, to obtain the speech keyword spotting result, and feed back the speech keyword spotting result to the main control system 404. The main control system 404 is further configured to receive the speech keyword spotting result from the computer-in-memory chip, and control the terminal device 403 to execute a corresponding response operation according to the speech keyword spotting result. The terminal device 403 is configured to execute the response operation corresponding to the speech keyword spotting result. The main control system 404 and the programmable logic unit 405 may be integrated in an FPGA (Field Programmable Gate Array) device, and may interact with the sound acquisition device 401, the computer-in-memory chip 402, and the terminal device 403.

In some embodiments, the main control system is a System on Chip (SOC), a Linux operating system may be deployed on the FPGA device as the main control system (PS) to control and schedule hardware resources, and based on the operating System, algorithms with strong versatility and low performance requirements are implemented.

FIG. 5 is a schematic diagram of an application scenario of a speech control system according to an embodiment of the present disclosure. As shown in FIG. 4 and FIG. 5, in some application scenarios, the main control system 404 and the programmable logic unit 405 are disposed in the FPGA device, the computer-in-memory chip 402 is implemented based on a FLASH architecture, and the FPGA device and the computer-in-memory chip 402 may interact with each other in multiple data transmission modes. For example, the data is transmitted between the FPGA device and the computer-in-memory chip 402 through an interface such as UART, SPI, I2C, INT, or I2S or the like. The FPGA device and the terminal device 403 may be connected to each other through an HDMI interface.

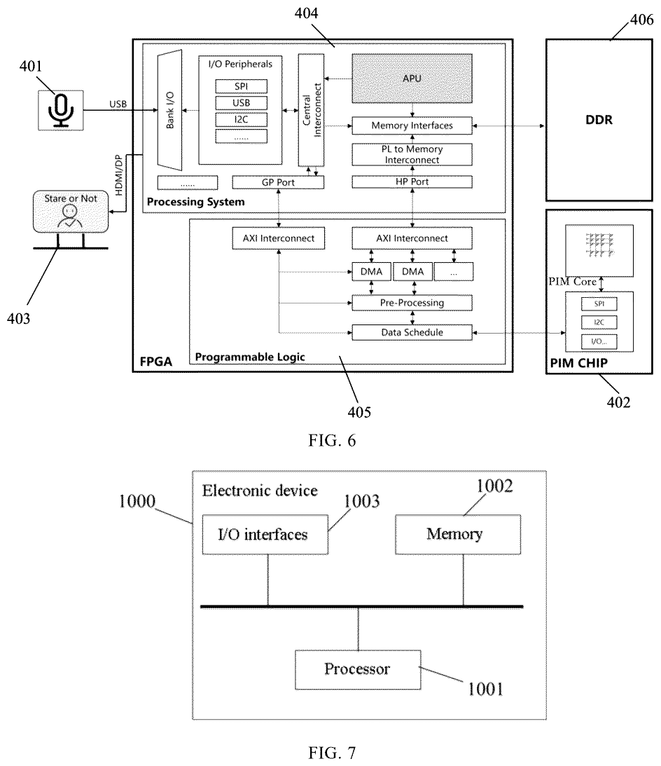

FIG. 6 is a schematic diagram of another application scenario of a speech control system according to an embodiment of the present disclosure. As shown in FIG. 6, in some application scenarios, the main control system 404 is disposed in the FPGA device together with the programmable logic unit (PL) 405, the computer-in-memory chip 402 is implemented based on an SRAM memory architecture, the main control system 404 and the computer-in-memory chip 402 interact with each other through the programmable logic unit 405, the main control system 404 and the terminal device 403 are connected to each other through an HDMI or DP interface, and the speech control system further includes an external memory DDR 406 interacting with the main control system 404 through a memory interface. The main control system 404 may store data from the sound acquisition device 401 or data from the programmable logic unit 405 in the external memory DDR 406, and may transmit the speech data acquired from the sound acquisition device 401 to the programmable logic unit 405. The programmable logic unit 405 may be configured to pre-process the speech data, e.g., perform the feature extraction and feature conversion processes, and then send the preprocessed data to the computer-in-memory chip 402 to perform the speech keyword spotting process by using the speech keyword spotting model. The computer-in-memory chip 402 may send the speech keyword spotting result obtained by the calculation of the speech keyword spotting model to the main control system 404 through the programmable logic unit 405, the main control system 403 then sends the speech keyword spotting result to the terminal device 403 for executing the corresponding response operation according to the speech keyword spotting result.

In the embodiment of the present disclosure, the speech keyword spotting model may be deployed on the computer-in-memory chip based on an SRAM/Flash architecture for computation acceleration, and an FPGA or an application processor is used as a main controller to deploy the main control system to interact with the sound acquisition device, the computer-in-memory chip and the terminal device, so as to realize functions such as the speech control and the speech interaction and the like. In the speech control system, the sound acquisition device, the main control system and the computer-in-memory chip may be integrated into the terminal device, the computer-in-memory chip uses the speech keyword spotting to control whether to wake up or control the terminal device, and a standby power of the device is expected to be in a μW level, so that the standby power consumption of the device can be greatly reduced. The application processor may adopt an RK3399 processor, which is an application processor chip with the low power consumption and the high performance.

In some embodiments, the sound acquisition device may be integrated in the terminal device. In some embodiments, the main control system may be integrated in the terminal device. In some embodiments, the computer-in-memory chip may alternatively be integrated into the terminal device.

In some embodiments, the terminal device may also be an intelligent speech control device, such as a home appliance with a speech control function, a wearable device, an intelligent speaker, a smart phone, a computer, a tablet, a television, or other electronic device, where the intelligent home appliance with the speech control function is a home appliance such as an intelligent speaker, a smart air conditioner, or a smart refrigerator or the like, and the wearable device is a smart watch, smart glasses, or the like.

In some embodiments, the sound acquisition device is a device for acquiring speech data, such as a microphone array.

In some application scenarios, the specific flow of waking up and controlling the terminal device by the speech control system includes steps 0) to 7).

The step 0) includes initializing the main control system.

The step 1) includes receiving, by the main control system, the speech data sent by the sound acquisition device;

The step 2) includes sending, by the main control system, an instruction of starting the detection for the wake-up words to the computer-in-memory chip, and waiting for the response of the computer-in-memory chip. Proceeding to the next step if the computer-in-memory chip responds to confirmation (that is, the response is to start the detection for the wake-up words). Otherwise, the main control system sends the instruction again until the computer-in-memory chip responds to confirmation.

The step 3) includes receiving, by the main control system, the speech keyword spotting result of the computer-in-memory chip and responding to confirmation. If the speech keyword spotting result indicates that the corresponding wake-up word is recognized, jumping to the step 4), otherwise, jumping to the step 3), and continuing to wait for the wake-up word detection result.

The step 4) includes controlling, by the main control system, the terminal device to wake up and feed back, for example, play speech including “I'm here”, “here”, or “can I help you”, and then waiting for a further speech keyword spotting result of the computer-in-memory chip.

When the terminal device is waked up from a screen-off state for the first time, the screen is also lightened.

The step 5) includes responding to confirmation when receiving the further speech keyword spotting result of the computer-in-memory chip; and jumping to the step 6) if the speech keyword spotting result indicates that the command word is recognized, and otherwise, jumping to the step 7).

The step 6) includes controlling, by the main control system, the terminal device to execute corresponding instructions, such as “open a video”, “increase volume” or the like, and jumping to the step 5).

The step 7) includes judging whether the command word is not recognized after timeout, if yes, jumping to the step 2), and if not, jumping to the step 5).

FIG. 7 is a block diagram of an electronic device according to an embodiment of the present disclosure.

Referring to FIG. 7, an embodiment of the present disclosure provides an electronic device 1000, including: at least one processor 1001, at least one memory 1002, and one or more I/O interfaces 1003 connected between the processor 1001 and the memory 1002. The memory 1002 stores one or more computer programs executable by the at least one processor 1001, and the one or more computer programs are executed by the at least one processor 1001 to cause the at least one processor 1001 to perform the speech data processing method described above.

The embodiment of the present disclosure further provides a computer-readable storage medium on which a computer program is stored, wherein the computer program, when executed by a processor, implements the above speech data processing method. The computer-readable storage medium may be a volatile or non-volatile computer-readable storage medium.

The embodiment of the present disclosure further provides a computer program product, which includes computer-readable codes or a non-volatile computer-readable storage medium carrying the computer-readable codes, and when the computer-readable codes run in the processor of the electronic device, the processor in the electronic device executes the above speech data processing method.

One of ordinary skill in the art will appreciate that all or some of the steps, systems, functional modules/units in the devices, disclosed above may be implemented as software, firmware, hardware, and suitable combinations thereof. In a hardware implementation, the division between functional modules/units mentioned in the above description does not necessarily correspond to the division of physical components. For example, one physical component may have multiple functions, or one function or step may be performed by several physical components in cooperation. Some or all of the physical components may be implemented as software executed by a processor, such as a Central Processing Unit (CPU), a digital signal processor, or a microprocessor, or as hardware, or as an integrated circuit, such as an application specific integrated circuit. Such software may be distributed on computer readable medium, which may include computer storage medium (or non-transitory medium) and communication medium (or transitory medium).

The term computer storage medium includes volatile and nonvolatile, removable and non-removable medium implemented in any method or technology for storage of information, such as computer readable instructions, data structures, program modules or other data, as is well known to one of ordinary skill in the art. Computer storage medium includes, but is not limited to, Random Access Memory (RAM), Read Only Memory (ROM), Erasable Programmable Read Only Memory (EPROM), Static Random Access Memory (SRAM), FLASH, or other memory technology, portable compact disc read-only memory (CD-ROM), Digital Versatile Disk (DVD) or other optical disk storage; magnetic cassettes, magnetic tape, magnetic disk storage or other magnetic storage; any other medium which may be used to store the desired information and which may be accessed by a computer. In addition, communication medium typically embodies computer readable instructions, data structures, program modules or other data in a modulated data signal such as a carrier wave or other transport mechanism and includes any information delivery medium, as is well known to one of ordinary skill in the art.

The computer-readable program instructions described herein may be downloaded from the computer-readable storage medium to the computing/processing devices, or to an external computer or an external storage device over a network, such as the internet, a local area network, a wide area network, and/or a wireless network. The network may include copper transmission cables, fiber optic transmission, wireless transmission, routers, firewalls, switches, gateway computers and/or edge servers. A network adapter card or a network interface in each computing/processing device receives the computer-readable program instructions from the network and forwards the computer-readable program instructions for storage in the computer-readable storage mediums in the computing/processing devices.

Computer program instructions for executing operations of the present disclosure may be assembler instructions, instruction set architecture (ISA) instructions, machine instructions, machine-related instructions, microcode, firmware instructions, state setting data, or source or object code written in any combination of one or more programming languages, including an object oriented programming language such as Smalltalk, C++ or the like and a conventional procedural programming language, such as “C” programming language or a similar programming language. The computer-readable program instructions may be executed entirely on the user's computer, partly on the user's computer, as a stand-alone software package, partly on the user's computer and partly on a remote computer, or entirely on the remote computer or server. In a case involving the remote computer, the remote computer may be connected to the user's computer through any type of network, including a local area network (LAN) or a wide area network (WAN), or connected to an external computer (for example, through the internet provided by an internet service provider). In some embodiments, various aspects of the present disclosure are implemented by personalizing an electronic circuit, which can execute the computer-readable program instructions, such as a programmable logic circuit, a field programmable gate array (FPGA), or a programmable logic array (PLA), by means of state information of the computer-readable program instructions.

The computer program product described herein may be embodied in hardware, software, or a combination thereof. In an alternative embodiment, the computer program product is embodied in a computer storage medium. In another alternative embodiment, the computer program product is embodied in a software product, such as a software development kit (SDK) or the like.

Various aspects of the present disclosure are described herein with reference to flowcharts and/or block diagrams of methods, apparatus (systems) and computer program products according to the embodiments of the present disclosure. It will be understood that each block in the flowchart and/or the block diagram, and combinations of blocks in the flowchart and/or the block diagram, can be implemented by computer-readable program instructions.

These computer-readable program instructions may be provided to a processor of a general purposed computer, a special purposed computer, or other programmable data processing apparatus to produce a machine, such that the instructions, when executed by the processor of the computer or other programmable data processing apparatus, create an apparatus implementing the functions/acts specified in one or more blocks in the flowchart and/or the block diagram. These computer-readable program instructions may alternatively be stored in a computer-readable storage medium, and theses instructions can direct a computer, programmable data processing apparatus, and/or other devices to function in a particular manner, such that the computer-readable medium storing the instructions includes a manufacture including instructions which implement various aspects of the functions/acts specified in one or more blocks in the flowchart and/or the block diagram.

The computer-readable program instructions may alternatively be loaded onto a computer, other programmable data processing apparatuses, or other devices to execute a series of operation steps on the computer, other programmable data processing apparatuses or other devices, to produce a computer implemented process, such that the instructions which are executed on the computer, other programmable data processing apparatuses or other devices implement the functions/acts specified in one or more blocks the flowchart and/or the block diagram.

The flowcharts and the block diagrams in the drawings illustrate architecture, functionality, and operation of possible implementations of systems, methods and computer program products according to various embodiments of the present disclosure. In this regard, each block in the flowchart or the block diagram may represent a module, a program segment, or a portion of instructions, which includes one or more executable instructions for implementing the specified logical function(s). In some alternative implementations, the functions noted in the block may occur in an order different from that noted in the figure. For example, two blocks shown in succession may, in fact, be executed substantially concurrently, or the blocks may sometimes be executed in the reverse order, depending upon the functionality involved. It should also be noted that each block in the block diagram and/or the flowchart, and combinations of blocks in the block diagram and/or the flowchart, may be implemented by a hardware-based system of a special purpose that executes the specified functions or acts, or implemented by a combination of a special purposed hardware and the computer instructions.

The present disclosure has disclosed example embodiments, and although specific terms are employed, they are used and should be interpreted in a generic and descriptive sense only and not for purposes of limitation. In some instances, features, characteristics and/or elements described in connection with a particular embodiment may be used alone or in combination with features, characteristics and/or elements described in connection with other embodiments, unless expressly stated otherwise, as would be apparent to one skilled in the art. It will, therefore, be understood by one of ordinary skill in the art that various changes in form and details may be made therein without departing from the scope of the present disclosure as set forth in the claims.

1. A speech data processing method, comprising:
acquiring speech data to be processed;
inputting the speech data to be processed into a programmable logic unit and performing a speech feature extraction on the speech data to be processed so as to obtain a speech feature vector corresponding to the speech data to be processed;
converting the speech feature vector into a multi-channel input feature map in the programmable logic unit;
inputting the input feature map into a computer-in-memory chip, and performing speech keyword spotting on the input feature map by using a speech keyword spotting model, which is configured on the computer-in-memory chip in advance, to obtain a speech keyword spotting result; and
feeding back the speech keyword spotting result to a main control system, wherein the main control system is configured to execute a response operation corresponding to the speech keyword spotting result according to the speech keyword spotting result.

2. The speech data processing method according to claim 1, wherein the performing the speech feature extraction on the speech data to be processed so as to obtain the speech feature vector corresponding to the speech data to be processed, comprises:
performing the speech feature extraction on the speech data to be processed with a preset speech feature extraction algorithm so as to obtain the speech feature vector corresponding to the speech data to be processed.

3. The speech data processing method according to claim 1, wherein the speech feature vector is a two-dimensional speech feature vector, and the converting the speech feature vector into the multi-channel input feature map comprises:
performing feature dimension expansion on the speech feature vector to obtain a three-dimensional speech feature vector;
copying the three-dimensional speech feature vector to obtain a plurality of three-dimensional speech feature vectors; and
splicing the plurality of three-dimensional speech feature vectors according to a channel dimension to obtain the multi-channel input feature map, wherein the channel dimension refers to a feature channel of the speech feature vectors.

4. The speech data processing method according to claim 1, wherein the speech keyword spotting model is a model constructed based on a convolution mixer network ConvMixer architecture, and comprises a feature sampling layer, the convolution mixer network and a classification output layer; and
the performing the speech keyword spotting on the input feature map by using the speech keyword spotting model, which is configured on the computer-in-memory chip in advance, to obtain the speech keyword spotting result, comprises:
performing a down-sampling process on the input feature map by using the feature sampling layer to obtain a down-sampled feature map;
performing a convolution mixer process on the down-sampled feature map by utilizing the convolution mixer network to obtain a speech recognition feature map; and
performing a keyword classification prediction process on the speech recognition feature map by using the classification output layer to obtain the speech keyword spotting result.

5. The speech data processing method according to claim 4, wherein the feature sampling layer comprises: a patch embedding layer, a first batch normalization layer and a first activation function layer; and
wherein the patch embedding layer is realized based on a convolution layer, and the activation function layer adopts a Swish activation function.

6. The speech data processing method according to claim 4, wherein the convolution mixer network comprises at least one convolution mixer network module, each convolution mixer network module comprises a space position convolution mixer unit and a channel position convolution mixer unit, and a space position mixer processing result output by the space position convolution mixer unit and an input of the space position convolution mixer unit are input to the channel position convolution mixer unit through a residual connection for a channel position mixer processing;
wherein the space position convolution mixer unit comprises: a depthwise separable convolution layer, a second batch normalization layer and a second activation function layer which are connected sequentially;
the channel position convolution mixer unit comprises: a pointwise convolution layer, a third batch normalization layer and a third activation function layer which are connected sequentially; and
wherein the second activation function layer and the third activation function layer both adopt Swish activation functions.

7. The speech data processing method according to claim 4, wherein the classification output layer comprises: an average pooling layer and a fully connected layer; and
wherein the fully connected layer is realized by adopting a convolution layer.

8. A method for training a speech keyword spotting model, comprising:
acquiring an initial training data set, wherein the initial training data set comprises a plurality pieces of initial training speech data and keyword labels corresponding to the plurality pieces of initial training speech data;
performing a data augmentation process on at least part of the initial training speech data in at least one data augmentation mode to obtain at least one piece of augmented training speech data and a keyword label corresponding to the augmented training speech data; and
training the speech keyword spotting model according to the initial training speech data and the augmented training speech data to obtain the trained speech keyword spotting model.

9. The method according to claim 8, wherein the at least one data augmentation mode comprises: a data mixing mode, a data noise adding mode, a negative sample construction mode, a velocity disturbance mode and a spectrum enhancement mode.

10. The method according to claim 8, wherein the training the speech keyword spotting model, comprises:
training the speech keyword spotting model based on a quantification aware training method.

11. (canceled)

12. A speech control system, comprising:
a sound acquisition device configured to acquire speech data to be processed in an environment where the sound acquisition device is located, and send the speech data to be processed to a main control system;
the main control system configured to receive the speech data to be processed acquired by the sound acquisition device, and send the speech data to be processed to a programmable logic unit;
the programmable logic unit configured to perform speech feature extraction on the speech data to be processed to obtain a speech feature vector corresponding to the speech data to be processed, and convert the speech feature vector into a multi-channel input feature map;
a computer-in-memory chip integrated with a speech keyword spotting model which is preset, and configured to perform speech keyword spotting on the input feature map by using a speech keyword spotting model, which is configured on the computer-in-memory chip in advance, to obtain a speech keyword spotting result;
the main control system further configured to receive the speech keyword spotting result from the computer-in-memory chip, and control a terminal device to execute a corresponding response operation according to the speech keyword spotting result; and
the terminal device configured to execute the response operation corresponding to the speech keyword spotting result.

13. An electronic device, comprising:
at least one processor; and
a memory communicatively connected to the at least one processor; wherein
the memory stores one or more computer programs executable by the at least one processor, and the one or more computer programs are executed by the at least one processor to cause the at least one processor to perform the speech data processing method according to claim 1.

14. A non-transitory computer-readable storage medium, on which a computer program is stored, wherein the computer program, when being executed by a processor, executes the speech data processing method according to claim 1.

15. An electronic device, comprising:
at least one processor; and
a memory communicatively connected to the at least one processor; wherein
the memory stores one or more computer programs executable by the at least one processor, and the one or more computer programs are executed by the at least one processor to cause the at least one processor to perform the method for training a speech keyword spotting model according to claim 8.

16. A non-transitory computer-readable storage medium, on which a computer program is stored, wherein the computer program, when being executed by a processor, executes the method for training a speech keyword spotting model according to claim 8.

17. The electronic device according to claim 13, wherein the performing the speech feature extraction on the speech data to be processed so as to obtain the speech feature vector corresponding to the speech data to be processed, comprises:
performing the speech feature extraction on the speech data to be processed with a preset speech feature extraction algorithm so as to obtain the speech feature vector corresponding to the speech data to be processed.

18. The electronic device according to claim 13, wherein the speech feature vector is a two-dimensional speech feature vector, and the converting the speech feature vector into the multi-channel input feature map comprises:
performing feature dimension expansion on the speech feature vector to obtain a three-dimensional speech feature vector;
copying the three-dimensional speech feature vector to obtain a plurality of three-dimensional speech feature vectors; and
splicing the plurality of three-dimensional speech feature vectors according to a channel dimension to obtain the multi-channel input feature map, wherein the channel dimension refers to a feature channel of the speech feature vectors.

19. The electronic device according to claim 13, wherein the speech keyword spotting model is a model constructed based on a convolution mixer network ConvMixer architecture, and comprises a feature sampling layer, the convolution mixer network and a classification output layer; and
the performing the speech keyword spotting on the input feature map by using the speech keyword spotting model, which is configured on the computer-in-memory chip in advance, to obtain the speech keyword spotting result, comprises:
performing a down-sampling process on the input feature map by using the feature sampling layer to obtain a down-sampled feature map;
performing a convolution mixer process on the down-sampled feature map by utilizing the convolution mixer network to obtain a speech recognition feature map; and
performing a keyword classification prediction process on the speech recognition feature map by using the classification output layer to obtain the speech keyword spotting result.

20. The electronic device according to claim 19, wherein the feature sampling layer comprises: a patch embedding layer, a first batch normalization layer and a first activation function layer; and
wherein the patch embedding layer is realized based on a convolution layer, and the activation function layer adopts a Swish activation function.

21. The electronic device according to claim 19, wherein the convolution mixer network comprises at least one convolution mixer network module, each convolution mixer network module comprises a space position convolution mixer unit and a channel position convolution mixer unit, and a space position mixer processing result output by the space position convolution mixer unit and an input of the space position convolution mixer unit are input to the channel position convolution mixer unit through a residual connection for a channel position mixer processing;
wherein the space position convolution mixer unit comprises: a depthwise separable convolution layer, a second batch normalization layer and a second activation function layer which are connected sequentially;
the channel position convolution mixer unit comprises: a pointwise convolution layer, a third batch normalization layer and a third activation function layer which are connected sequentially; and
wherein the second activation function layer and the third activation function layer both adopt Swish activation functions.
